(19) United States
(12) Patent Application Publication
(10) Pub. No.: US 2009/0284012 A1
(43) Pub. Date: Nov. 19, 2009

(54) Tower Construction for a Wind Turbine

(75) Inventor: Henning Mortensen, Randers (DK)

Correspondence Address: COHEN, PONTANI, LIEBERMAN & PAVANE LLP, 551 FIFTH AVENUE, SUITE 1210, NEW YORK, NY, 10176, US

(73) Assignee: VESTAS WIND SYSTEMS A/S, Randers SV (DK)

(21) Appl. No.: 12/306,458

(22) PCT Filed: May 24, 2007
(86) PCT No.: PCT/EP2007/055042

§ 371 Date: Mar. 6, 2009

(30) Foreign Application Priority Data
Jun. 29, 2006 (DK) PA 2006 00868

(51) Int. Cl. F03D 11/04; F03D 7/00; E04H 12/00

(52) U.S. Cl. 290/44; 52/40

(57) ABSTRACT

A handling system for a wind turbine nacelle in connection with self-loading or self-unloading of the nacelle to or from a vehicle. The system comprises two or more lifting apparatus, where the lifting apparatus are engaged with lifting areas of a load carrying structure of the nacelle. The lifting areas are a part of the load carrying structure or are integrated in the load carrying structure, and where the lifting apparatus lifts by applying linear force to the load carrying structure of the nacelle. The invention further relates to a method for vertical displacement of a wind turbine nacelle and a wind turbine nacelle prepared for self-loading or self-unloading to or from a vehicle.

### FIELD OF THE INVENTION

The present invention relates to a tower construction for a wind turbine. More particularly, the present invention relates to a tower construction which is improved in terms of fatigue and strength as compared to prior art tower constructions.

### BACKGROUND OF THE INVENTION

In wind turbines it is necessary to provide various devices and connections along a longitudinal direction defined by the tower construction. For instance, it is normally necessary to provide electrical connections between the nacelle and the part of the tower construction positioned at ground level in order to be able to communicate electrical signals to and from the nacelle. Such electrical signals may include control signals for controlling the wind turbine (communicated to the nacelle) and electrical power generated by a generator positioned in the nacelle (communicated from the nacelle). In order to communicate such signals, appropriate cables are normally positioned in a hollow part of the tower construction. Furthermore, the cables are normally fixed to a side wall of the tower construction, e.g. by means of holders which have been fixedly attached to the side wall, e.g. welded to the side wall.

In addition to cables, it may be necessary to attach other devices to the side walls of the tower construction, e.g. light armatures, ladders, resting platforms, supply lines for fluids, such as gas, air, water, oil, e.g. for hydraulic systems, etc. Such devices may be fitted directly onto a side wall of the tower construction, or they may be fitted in appropriate holders which have been fitted to the side wall.

When holders or devices are welded to a side wall of the tower construction, weak points of the tower construction will appear at the welding sites. Accordingly, the overall strength of the tower construction is decreased, e.g. in terms of fatigue. This is very undesirable.

It has been attempted to solve the problems outlined above by using holders which may be attached to a side wall of the tower construction by means of magnets. However, it is not possible to use this solution when the tower construction is made from a material which is not magnetisable, e.g. concrete.

### SUMMARY OF THE INVENTION

It is, thus, an object of the invention to provide a tower construction for a wind turbine, the tower construction being stronger than prior art tower constructions.

It is a further object of the invention to provide a tower construction for a wind turbine, the tower construction being easier to build than prior art tower constructions.

It is an even further object of the invention to provide a method of mounting a cable in a tower construction for a wind turbine in a manner which is safer than corresponding prior art methods.

It is an even further object of the invention to provide a control module which is easily installed in a tower construction for a wind turbine.

According to a first aspect of the invention the above and other objects are fulfilled by providing a tower construction for a wind turbine (WTG), the wind turbine further comprising a set of blades and a nacelle enclosing at least a transmission system and power generating means, the tower construction comprising:
a first structure being adapted to support the wind turbine structure, including at least the first structure, the blades, the nacelle and the parts enclosed by the nacelle, said first structure defining a longitudinal direction, and said first structure having at least one wall part extending along the longitudinal direction, and
a second structure being adapted to carry its own weight, said second structure being arranged along the longitudinal direction defined by the first structure, and said second structure extending along at least a substantial part of the length of the first structure in the longitudinal direction,

wherein the first structure and the second structure are positioned relatively to each other in such a manner that no fixed connections between the second structure and the wall part(s) of the first structure are formed.

The transmission system is used for transmitting torque provided by rotating blades to the power generating means. The transmission system preferably is or comprises a gear system.

The power generating means preferably is or comprises a generator which is connected in a suitable manner to a power grid.

The first structure is adapted to support the wind turbine structure. Thus, the first structure performs the primary function of the tower construction, i.e. it supports and carries the entire wind turbine. The first structure defines a longitudinal direction. A tower construction for a wind turbine normally has an elongated shape, thereby defining a longitudinal direction. When the wind turbine is positioned at its operating site the longitudinal direction will normally be an at least substantially vertical direction extending between ground level and the position of the nacelle. However, when the tower construction is being transported, the longitudinal direction will normally be at least substantially horizontal.

The first structure has at least one wall part. The wall part(s) may be inner and/or outer wall parts. In the case that the first structure is at least substantially massive it will have only outer wall part(s). However, in the case that the first structure is hollow, it may comprise inner wall parts as well as outer wall parts, the inner wall parts being arranged in the interior of the hollow construction.

The second structure is adapted to carry its own weight. Preferably, this is the only structural load which the second structure is subjected to. Thus, the second structure does not share the structural load of the wind turbine with the first structure, i.e. the first structure alone is capable of carrying the wind turbine structure, and removing the second structure from the tower construction would therefore have no structural effect.

The second structure is arranged along the longitudinal direction defined by the first structure, and it extends along at least a substantial length of the first structure in this direction. Thus, the length of the first structure and the length of the second structure along the longitudinal direction are at least substantially identical, or at least of the same order of magnitude. However, the lengths are not necessarily exactly identical. For instance, the second structure may have a length which is 5% or 10% shorter than the length of the first structure. In this case the second structure may be arranged relatively to the first structure in such a manner that, when the wind turbine has been installed at the operation site, it extends from ground level to a position which is lower than the uppermost part of the first structure. Thereby the second structure may advantageously perform tasks which are normally performed by the tower construction of a wind turbine, but which are not directly related to carrying structural loads. Such tasks may include fixing cables and wires, carrying lightning armatures, carrying ladders or lifts, etc. This is very advantageous because it is thereby avoided that such items need to be fixed directly onto the first structure, i.e. the load carrying structure, and thereby the risk that this structure is weakened is considerably reduced or even eliminated.

The first structure and the second structure are positioned relatively to each other in such a manner that no fixed connections between the second structure and the wall part(s) of the first structure are formed. In the present context the term ‘fixed connection’ should be interpreted to mean a connection which attaches the second structure directly to a wall part of the first structure, preferably in an at least substantially irreversible manner. Examples of fixed connections are weldings, rivets and screw connections. As mentioned above, such fixed connections tend to weaken the tower construction in terms of fatigue, and it is therefore an advantage that such connections are avoided. Temporary connections, such as abutments, should not be regarded as fixed connections.

Accordingly, the present invention provides a tower construction which is stronger, e.g. in terms of fatigue, than prior art tower constructions. Simultaneously, the tower construction of the invention allows various items, such as cables, wiring, lightning armatures, ladders, etc. to be attached to the tower construction without compromising the overall strength of the tower construction.

The second structure may be provided with one or more supporting arms being adapted to abut at least one of the wall part(s) of the first structure, thereby reducing deflections of the second structure in a direction substantially transverse to the longitudinal direction defined by the first structure. Thus, the supporting arm(s) stabilizes the second structure in terms of deflections. However, an abutment does not give rise to structurally weak points since it is not a fixed connection as defined above.

Furthermore, one or more supporting arms may further be adapted to dampen relative oscillations between the first structure and the second structure. According to this embodiment the second structure functions as a dampening means for possible oscillations in the tower construction. Thus, dampening is provided without the need for additional parts.

The second structure may be arranged in an interior part of the first structure. In this case the first structure is a hollow structure, i.e. it forms an interior in which the second structure can be arranged. Since the first structure surrounds the second structure, the second structure may be protected from wind and weather by the first structure if the first structure is at least substantially closed. Accordingly, there is no need to provide additional protection for the second structure or for any parts or items attached to the second structure. Furthermore, the access to the second structure and any parts or items attached thereto can easily be controlled by means of a lockable door arranged in the first structure.

Alternatively, the first structure may be arranged in an interior part of the second structure, or the second structure may be arranged along an exterior part of the first structure.

The first structure may form an at least substantially closed part. In this case the first structure preferably forms a hollow interior part which is at least substantially enclosed by the first structure. The first structure may comprise solid walls, e.g. concrete walls or stainless steel walls. Alternatively, the first structure may comprise walls which are not solid, but which still enclose a hollow interior part. This may, e.g., be obtained if at least part of the first structure forms a grid-like pattern.

The second structure may form a grid-like part. In this case the second structure is preferably a grid tower arranged in an interior part of the first structure, the first structure forming an at least substantially closed part as described above. Thus, according to a preferred embodiment the first structure is at least substantially closed, and a grid-like second structure is arranged in an interior part of the first structure.

The second structure may be adapted to carry one or more components of the wind turbine. At least one of the component(s) may be of a kind which needs to extend along at least a substantial part of the second structure along the longitudinal direction. Examples of such components are power cables or busbars for leading generated power from the wind turbine to a power grid, supply lines for supplying power, fluids, control signals, etc. to/from the nacelle, stairs, ladders, lift rails, safety measures with respect to items to be moved in the tower construction, etc.

Alternatively or additionally, components which do not extend along at least a substantial part of the second structure may be carried by the second structure. Examples of such components are resting platforms, electrical installations, such as lightning armatures or electrical sockets, abutment arms as described above, dampening arrangements for dampening vibrations and/or oscillations, anchorages for snap-hooks, etc.

At least one of the component(s) may be pre-mounted on the second structure. In this case time is saved when the tower construction is being installed on the operation site, since the pre-mounted component(s) will not have to be fitted on site. Thereby logistics are improved, and manufacturing is made easier and more efficient.

The second structure may be adapted to at least substantially enclose one or more parts which need to be moved along the longitudinal direction defined by the first structure. In this case the second structure defines an at least substantially closed space in which the moving parts can be arranged. Thus, the second structure provides protection for persons working at or near the tower construction in the sense that it prevents such persons from being located at a position where there is a risk that the moving parts may accidentally fall. This is very advantageous. Examples of parts which need to be moved along the longitudinal direction are power cables, busbars, supply lines, various wires, etc. Such parts are usually elevated or lowered using a crane, and there is a risk that something breaks during this operation, thereby causing the heavy parts to fall.

The embodiment described above is particularly advantageous when the second structure is arranged in an interior part of the first structure.

The tower construction may be formed by a number of individual tower sections, each tower section comprising a first structure section and a second structure section, and each of the first structure sections may form part of the first structure, and each of the second structure sections may form part of the second structure. Modern tower constructions are so tall that it is often very difficult, or even impossible, to transport a complete tower construction. Therefore it is sometimes advantageous to construct the tower construction by means of a number of individual tower sections, each tower section defining a specific part of the tower construction along the longitudinal direction defined by the first structure. According to this embodiment of the invention, each of the tower sections comprises a first structure section and a second structure section. Accordingly, when the tower sections are assembled at the operation site, the first structure sections in combination will form the first structure, and the second structure sections in combination will form the second structure. Thereby the resulting tower construction comprises a first structure and a second structure as defined above. Thus, the tower construction is easily assembled and installed at the operation site. Furthermore, it is an advantage that as much of the tower construction as possible can be assembled before the tower construction is transported to the operation site, since the logistics are thereby improved.

Each of the first structure sections may be provided with at least one flange for providing a connection interface to an adjacent first structure section, and each of the second structure sections may be fixed to a flange of a corresponding first structure section. Since each of the second structure sections is fixed to a flange of a corresponding first structure section, the sections do not move relatively to each other during transport of the tower section, and it is thereby possible to assemble the tower construction in a more precise manner. Furthermore, since the flange does not form part of the walls parts of the first structure, the strength of the first structure is not compromised, even though a fixed connection is formed between the first structure and the second structure. Furthermore, the fixed connection appears at a position where it under any circumstance is necessary to join two tower sections, and thereby it does not contribute further to weakening of the tower construction.

The tower construction may further comprise a cable unit arranged at a lower part of the tower construction, and one or more cables extending from the cable unit towards the nacelle along the second structure. According to this embodiment, all cables, supply lines, wires, etc. which are needed in order to operate the wind turbine are preferably delivered in the cable unit. The cable unit is positioned on top of a foundation, and the tower construction is positioned or assembled on top of the foundation, and in such a manner that the cable unit is enclosed by the tower construction. When the wind turbine has been installed, the cable unit is opened, and the cables, supply lines and wires positioned therein are elevated from the cable unit towards the nacelle, e.g. using a crane. The cable unit preferably comprises or is connected to a control unit for supplying control signals to the wind turbine.

It is an advantage to provide the cables, supply lines, wires, etc. needed for operating the wind turbine in a cable unit as described above. Thereby it can be ensured from the onset that everything needed is present when the wind turbine is installed at the operation site, and logistics are improved.

According to a second aspect of the invention the above and other objects are fulfilled by providing a method of mounting at least one cable in a wind turbine, the wind turbine comprising a tower construction, a set of blades and a nacelle enclosing at least a transmission system and power generating means, the method comprising the steps of:
providing a cable unit containing at least one cable to be mounted in the wind turbine,
positioning the cable unit at a lower part of the tower construction,
lifting the cable(s) from the cable unit towards an upper part of the wind turbine, said upper part comprising the nacelle.

This method has already been described above.

The tower construction may comprise a first structure being adapted to support the wind turbine structure, including at least the first structure, the blades, the nacelle and the parts enclosed by the nacelle, and a second structure being adapted to carry its own weight, and the step of lifting the cable(s) may comprise lifting the cable(s) along the second structure. According to this embodiment, the second structure may advantageously operate as a safety measure as described above.

According to a third aspect of the invention the above and other objects are fulfilled by providing a control module for a wind turbine, the control module comprising:
A control unit comprising electronic components necessary for controlling a wind turbine, and
a cable unit comprising cables for interconnecting the control unit to a nacelle part of the wind turbine, said cables being arranged in the cable unit in such a manner that they may be lifted from the cable unit to the nacelle part during installation of the wind turbine.

It should be noted that a skilled person would readily recognize that any feature described in combination with the first aspect of the invention may equally be combined with the second and third aspects of the invention, any feature described in combination with the second aspect of the invention may equally be combined with the first and third aspects of the invention, and any feature described in combination with the third aspect of the invention may equally be combined with the first and second aspects of the invention.

Examples of electronic components necessary for controlling a wind turbine include, but are not limited to, control circuits, including inverters, switches, transformers, switchgears, controllers, central processing units (CPU), remote controls, circuit breakers, uninterruptible power supplies (UPS), phase comparator converters, test equipment, etc.

Examples of cables for interconnecting the control unit to a nacelle part of the wind turbine include, but are not limited to, power cables or busbars for leading produced power from the wind turbine to a power grid, supply lines for supplying power, control signals, fluids, such as hydraulic fluid, water, air, etc., between the control unit and parts positioned at or near the nacelle, wires, etc.

The control module may be positioned in a container. In this case the control unit is very easily delivered to the operation site of the wind turbine as described above.

### BRIEF DESCRIPTION OF THE DRAWINGS

The invention will now be described in further detail with reference to the accompanying drawings in which

FIG. 1 is a perspective view of a tower construction according to an embodiment of the invention, and

FIGS. 2-7 show various parts of the tower construction of FIG. 1, and from various angles.

### DETAILED DESCRIPTION OF THE DRAWINGS

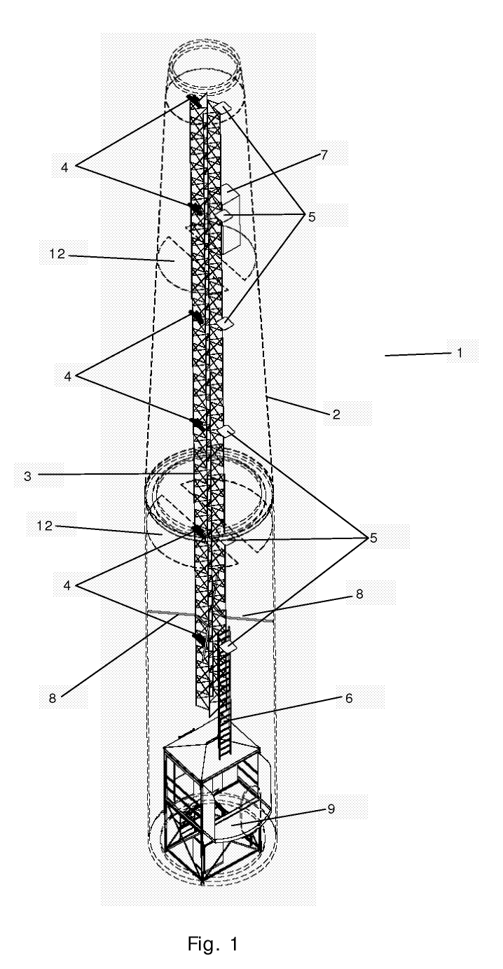

FIG. 1 is a perspective view of a tower construction 1 according to an embodiment of the invention. The tower construction 1 comprises a first structure 2 and a second structure 3. The first structure 2 forms a closed part defining a hollow interior part in which the second structure 3 is arranged. For the sake of clarity the contours of the first structure 2 are shown by means of a dashed line, thereby allowing the second structure 3 to be seen.

The second structure 3 is a grid-like structure adapted to carry various components or items which are needed in the tower construction 1. This will be described in further detail below.

The first structure 2 is adapted to support and carry the load from the wind turbine structure, including it own weight and the weight from a nacelle and any components or parts positioned in the nacelle. Thus, the first structure 2 constitutes the structural, load carrying part of the tower construction 1.

As mentioned above, the second structure 3 has a number of various components attached thereto, including a number of lightning armatures 4 for providing light inside the tower construction 1, and a number of resting platforms 5 where a person climbing up or down the tower construction 1 may rest.

The second structure 3 is furthermore provided with a ladder 6 which a person may climb in case it is necessary to reach components positioned along the second structure 3 and/or parts positioned in the nacelle. In FIG. 1 only the lowermost part of the ladder 6 is shown. It should, however, be noted that the ladder 6 preferably extends along the entire length of the second structure 3, thereby allowing access to any component attached to the second structure 3 and to the nacelle.

The second structure 3 is furthermore provided with a lift 7, i.e. the rails in which the lift 7 moves are attached to the second structure 3. The purpose of the lift 7 is also to allow persons to enter the nacelle.

Finally, the second structure 3 is provided with two service and lift platforms 12. From the service and lift platforms 12 it is possible to enter/leave the lift 7, and it is possible to provide maintenance to the tower construction 1 and/or to various components attached to the second structure 3.

Two supporting arms 8 are also attached to the second structure 3. The supporting arms 8 are arranged in such a manner that they abut a wall part of the first structure 2. Thereby the supporting arms 8 prevent sideways deflections of the second structure 3, and thereby a stabile construction is achieved. Furthermore, the supporting arms 8 serve to dampen relative oscillations and vibrations between the first structure 2 and the second structure 3.

At a lower part of the tower construction 1 a control module 9 is positioned. The control module 9 contains various electronic equipment necessary for controlling the wind turbine.

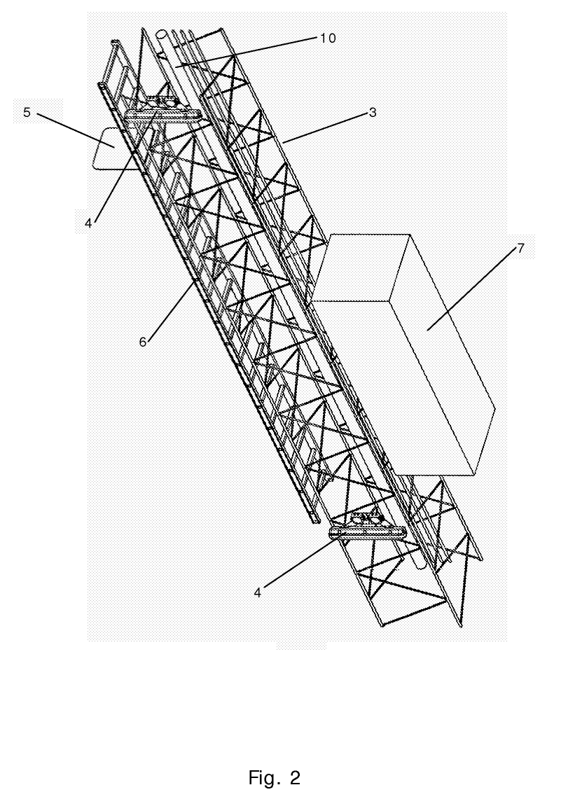

FIG. 2 is a perspective view of a part of the tower construction 1 of FIG. 1. FIG. 2 shows a part of the second structure 3 where a lift 7 is positioned. FIG. 2 further shows lightning armatures 4, resting platforms 5 and a ladder 6 attached to the second structure 3 as described above.

Furthermore, a power cable 10 is attached to the second structure 3. The power cable 10 is attached in an interior part of the second structure 3. Thereby the second structure 3 functions as a safety measure in the sense that in case the power cable 10 should fall, e.g. during installation of the power cable 10, it does not fall at positions outside the perimeter defined by the second structure 3. Accordingly, persons located outside this perimeter are not at risk of being hit by a falling power cable 10. This will be described in further details below.

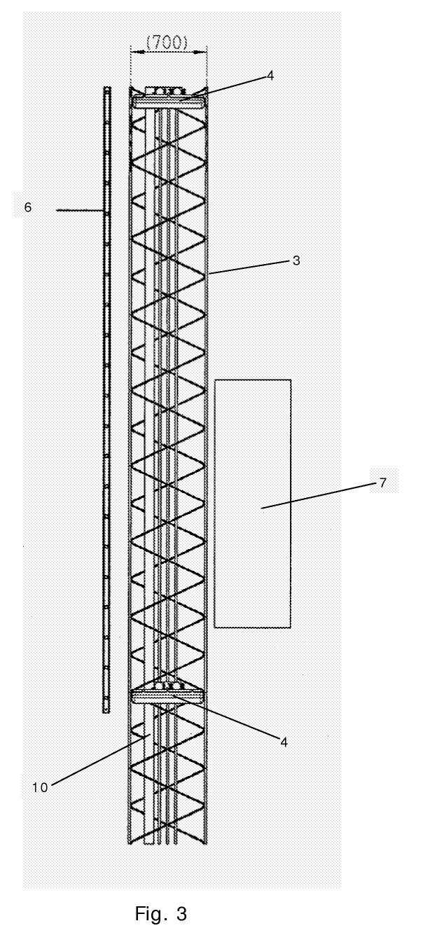

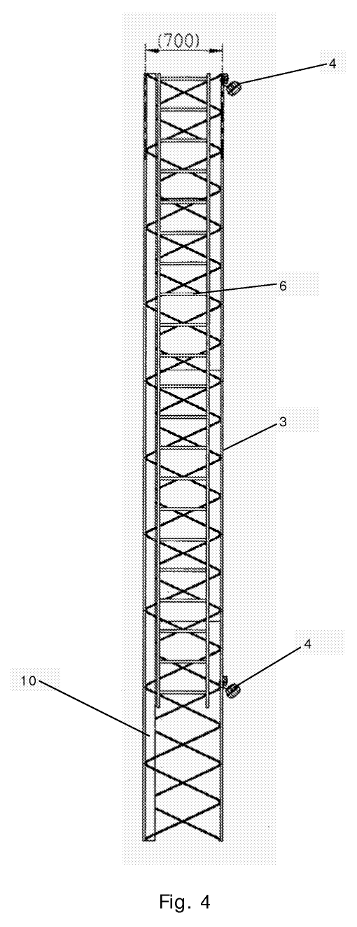

FIGS. 3 and 4 are side views from two different angles of the part of the second structure 3 shown in FIG. 2.

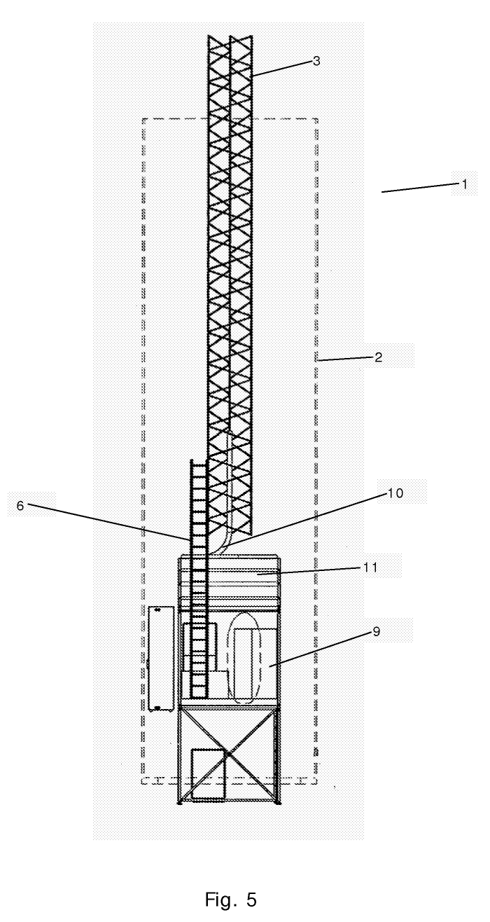

FIG. 5 is a cross sectional view of part of the tower construction 1 of FIG. 1. The first structure 2 is indicated by means of a dashed line. FIG. 5 shows a lower part of the tower construction 1. Accordingly, the ladder 6 and the control module 9 are visible.

On top of the control module 9 a cable unit 11 is positioned. The cable unit 11 contains various cables, supply lines, wires, etc. necessary for supplying power, various fluids, etc. to and from the nacelle. The cable unit 11 is delivered with all the necessary cables etc. packed therein and ready to install.

In FIG. 5 a power cable 10 is in the process of being elevated inside a perimeter defined by the second structure 3. It can be seen that this is easily done from the cable unit 11. Furthermore, it is clear that persons can safely stay outside the perimeter defined by the second structure 3.

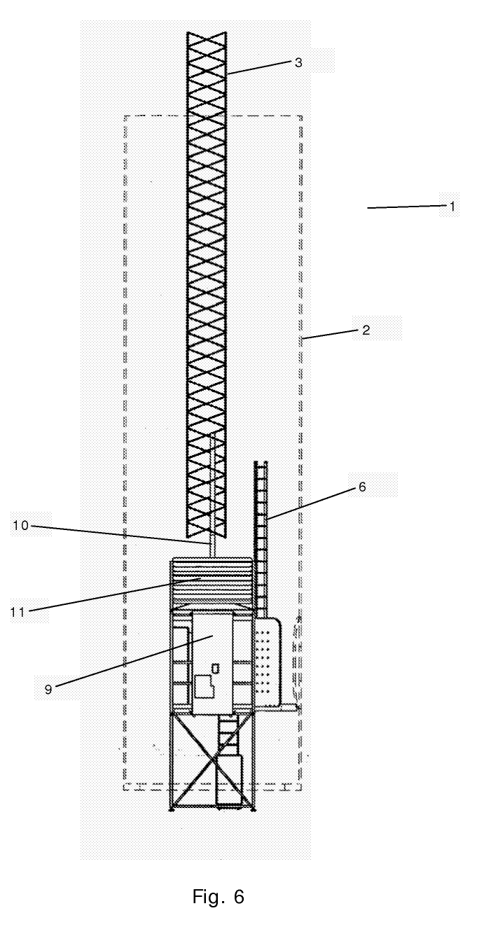

FIG. 6 shows the part of the tower construction 1 shown in FIG. 5 from a different angle.

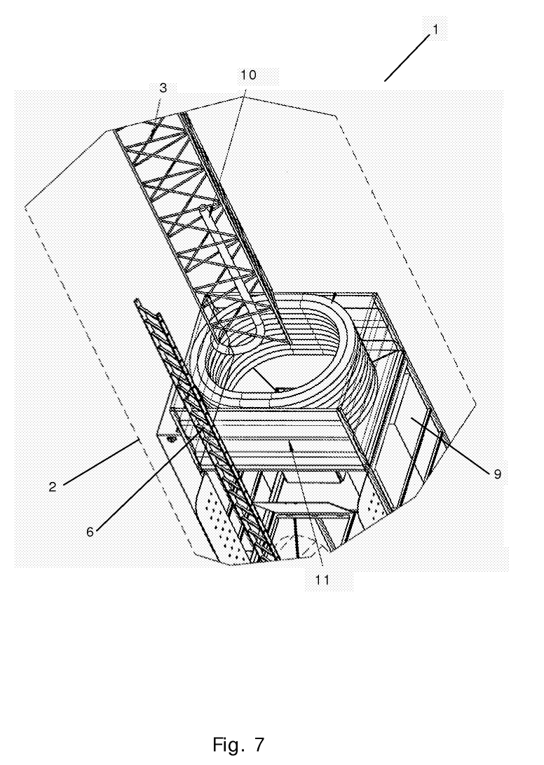

FIG. 7 is a perspective view of a lower part of the tower construction 1 of FIG. 1. Thus, the control module 9 and the cable unit 11 are visible. A power cable 10 is in the process of being elevated from the cable unit 11. FIG. 7 shows how the power cable 10 is arranged in the cable unit 11 in order to allow it to be easily installed in the tower construction 1.

1-17. (canceled)

18. A tower construction for a wind turbine (WTG), the wind turbine comprising a set of blades and a nacelle enclosing at least a transmission system and power generating means, the tower construction comprising:
a first structure being adapted to support the wind turbine structure, including at least the first structure, the blades, the nacelle and the parts enclosed by the nacelle, said first structure defining a longitudinal direction, and said first structure having at least one wall part extending along the longitudinal direction, and
a second structure being adapted to carry its own weight and one or more components of the wind turbine, said second structure being arranged along the longitudinal direction defined by the first structure, and said second structure extending along at least a substantial part of the length of the first structure in the longitudinal direction,
wherein the first structure and the second structure are positioned relatively to each other in such a manner that no fixed connections between the second structure and the wall part(s) of the first structure are formed.

19. The tower construction according to claim 18, wherein the second structure is provided with one or more supporting arms being adapted to abut at least one of the wall part(s) of the first structure, thereby reducing deflections of the second structure in a direction substantially transverse to the longitudinal direction defined by the first structure.

20. The tower construction according to claim 2, wherein the one or more supporting arms is/are further adapted to dampen relative oscillations between the first structure and the second structure.

21. The tower construction according to claim 18, wherein the second structure is arranged in an interior part of the first structure.

22. The tower construction according to claim 18, wherein the first structure forms an at least substantially closed part.

23. The tower construction according to claim 18, wherein the second structure forms a grid-like part.

24. The tower construction according to claim 18, wherein at least one of the component(s) is pre-mounted on the second structure.

25. The tower construction according to claim 18, wherein the second structure is adapted to at least substantially enclose one or more parts which need to be moved along the longitudinal direction defined by the first structure.

26. The tower construction according to claim ??, wherein the tower construction is formed by a number of individual tower sections, each tower section comprising a first structure section and a second structure section, and wherein each of the first structure sections forms part of the first structure, and each of the second structure sections forms part of the second structure.

27. The tower construction according to claim 26, wherein each of the first structure sections is provided with at least one flange for providing a connection interface to an adjacent first structure section, and wherein each of the second structure sections is fixed to a flange of a corresponding first structure section.

27. The tower construction according to claim 18, further comprising a cable unit arranged at a lower part of the tower construction, and one or more cables extending from the cable unit towards the nacelle along the second structure.

28. A method of mounting at least one cable in a wind turbine, the wind turbine comprising a tower construction, a set of blades and a nacelle enclosing at least a transmission system and power generating means, the tower construction comprising a first structure being adapted to support the wind turbine structure, including at least the first structure, the blades, the nacelle and the parts enclosed by the nacelle, and a second structure being adapted to carry its own weight, the method comprising the steps of:
providing a cable unit containing at least one cable to be mounted in the wind turbine,
positioning the cable unit at a lower part of the tower construction,
lifting the cable(s) from the cable unit towards an upper part of the wind turbine, along and enclosed by the second structure, said upper part comprising the nacelle.

29. A control module for a wind turbine, the control module comprising;
a control unit comprising electronic components necessary for controlling a wind turbine, and
a cable unit comprising cables for interconnecting the control unit to a nacelle part of the wind turbine, said cables being arranged in the cable unit in such a manner that they may be lifted from the cable unit to the nacelle part during installation of the wind turbine.

30. The control module according to claim 29, wherein the control module is positioned in a container.
